(19) United States
(12) Patent Application Publication
(10) Pub. No.: US 2005/0010775 A1
(43) Pub. Date: Jan. 13, 2005

(54) Mail receiving/transmitting system and method with document identification function

(76) Inventor: Kuei-Fu Hsu, Taipei County (TW)

Correspondence Address: J.C. Patents, Inc., Suite 250, 4 Venture, Irvine, CA, 92618, US

(21) Appl. No.: 10/778,773

(22) Filed: Feb. 12, 2004

(30) Foreign Application Priority Data
Jul. 10, 2003 (TW) 92118827

(51) Int. Cl. H04L 9/00

(52) U.S. Cl. 713/176

(57) ABSTRACT

A mail receiving/transmitting system and method with document identification function, which is adapted to a network mailing system with a transmitting end and a receiving end, is provided. The mail receiving/transmitting system includes a bit operation unit, a watermark generator, a watermark decoder and a document identification unit. The bit operation unit generates a first padding value according to a specific part of the mail being mailed by the transmitting end using a predetermined bit operation method. The watermark generator converts the first padding value to a watermark, which is added to the mail before the mail is transmitted. The receiving end receives the mail and decodes the watermark on the mail to obtain the first padding value. Moreover, the bit operation unit in the receiving end also generates a second padding value according to the same part of the mail and the bit operation method as generating the first padding value. Thereafter, the first padding value is compared with the second padding value to ensure the content of the mail remaining identical during mail transmission.

### CROSS-REFERENCE TO RELATED APPLICATION

This application claims the priority benefit of Taiwan application serial no. 92118827, filed on Jul. 10, 2003.

### BACKGROUND OF THE INVENTION

1. Field of the Invention

The present invention relates to a mail receiving/transmitting system and mail processing method, and more particularly, to a mail receiving/transmitting system and method with mail identification function.

2. Description of the Related Art

In the modern commercial-industrial environment where the Internet is prevailing, more and more documents have been delivered via unbeatably prompt e-mail instead of traditional document delivery methods. However, since contents of the e-mail being delivered via network may be tampered, various encryption methods are introduced to prevent e-mail contents from peeking or tampering.

Exponential operation method is commonly applied to encryption method in present time. Such encryption method is highly cryptic which is appropriate for protecting e-mail from peeking. However, most users require correctness of delivery rather than highly encrypted e-mail. Yet e-mail being peeked is not desirable, whereas time consuming of encryption is neither. To retain correctness for most e-mail as well as reducing encryption operating time has become an urgent object to be achieved.

### SUMMARY OF THE INVENTION

In the light of the preface, it is a primary object of the present invention to provide a mail receiving/transmitting system and a method with document identification function, in which a simple operation method is used to achieve the object of identifying the e-mail correctness.

The present invention provides a mail receiving/transmitting system with document identification function, which applies to a network mailing system having a transmitting end and a receiving end to identify the correctness of the e-mail transmitted by the network mailing system. The mail receiving/transmitting system with document identification function comprises a bit operation unit and a document identification unit, wherein the bit operation unit calculates bits of a specific text block in the e-mail, so as to obtain padding values to the e-mail before transmission and after receiving. The document identification unit obtains and compares the variance of the padding values between before transmitting the e-mail and after receiving the e-mail, and to ensure correctness of e-mail contents.

In accordance with a preferred embodiment of the present invention, the bit operation unit obtains a text block according to a predetermined direction in the e-mail, and the padding values are concatenated to the end of this predetermined direction. Further, the predetermined operation method used by the bit operation unit comprises at least one of the XOR (Exclusive OR) operation method and the parity check method. Moreover, the bit operation unit is able to extract a partial data only from the text block, so as to obtain the padding values accordingly with predetermined direction.

Furthermore, in accordance with another preferred embodiment of the present invention, the mail receiving/transmitting system with document identification function further comprises a watermark generator and a watermark decoder. When the network mailing system prepares to send the e-mail, the watermark generator converts the padding values generated above to a corresponding watermark, and saves the watermark to a certain position of the e-mail. When the network mailing system has received the e-mail, the watermark decoder converts the watermark in the e-mail to the padding value for document identification unit for comparison.

Moreover, the present invention further provides a mail receiving/transmitting method with document identification function, which is adapted to the network mailing system. In the mail receiving/transmitting method, when the e-mail is to be sent, a corresponding set of first padding values is obtained by calculating bits of a specific text block in the e-mail according to a predetermined operation parameter, and the first padding value is concatenated to the e-mail which is then transmitted to a user host located in the receiving end via the network mailing system. After the e-mail is received, the user host calculates the e-mail and obtains another set of second padding values according to the same operation parameter. The second padding value is then compared with the first padding value extracted from the same e-mail, so as to determine the correctness of the e-mail contents.

In accordance with another preferred embodiment of the present invention, the predetermined direction for calculating the specific text block in the e-mail is at least one of the top to bottom, bottom to top, left to right, and right to left directions, and the operation method for calculating is either the XOR operation method or the parity check method.

In accordance with still another preferred embodiment of the present invention, the step mentioned above for concatenating the first padding value to the e-mail further comprises converting the first padding values into a corresponding watermark and concatenating this watermark into the e-mail. The step for obtaining the first padding value from the e-mail further comprises converting the watermark in the e-mail into the first padding value.

The present invention generates a padding value by using a simple bit operation method according to the mail contents, such as the sender, subject, sending date, and the text body. Therefore, after the e-mail is transmitted, the correctness of the delivered mail contents is verified by comparing the difference between the pre-delivery padding values and the post-delivery padding values, where both sets of padding values are generated via same operation. Notice that a large variety of methods are available thus are difficult to be cracked.

### BRIEF DESCRIPTION OF THE DRAWINGS

The accompanying drawings are included to provide a further understanding of the invention, and are incorporated in and constitute a part of this specification. The drawings illustrate embodiments of the invention, and together with the description, serve to explain the principles of the invention.

FIG. 1A is a schematic block diagram illustrating a system of a first preferred embodiment according to the present invention.

FIG. 1B is a schematic structure block diagram illustrating a system of a second preferred embodiment according to the present invention.

FIG. 2 is a schematic block diagram illustrating a system of a third preferred embodiment according to the present invention.

FIG. 3 is a schematic block diagram illustrating a system of a fourth preferred embodiment according to the present invention.

FIG. 4 is a flow-chart illustrating the process steps of the first and the second preferred embodiments according to the present invention.

### DESCRIPTION OF THE PREFERRED EMBODIMENTS

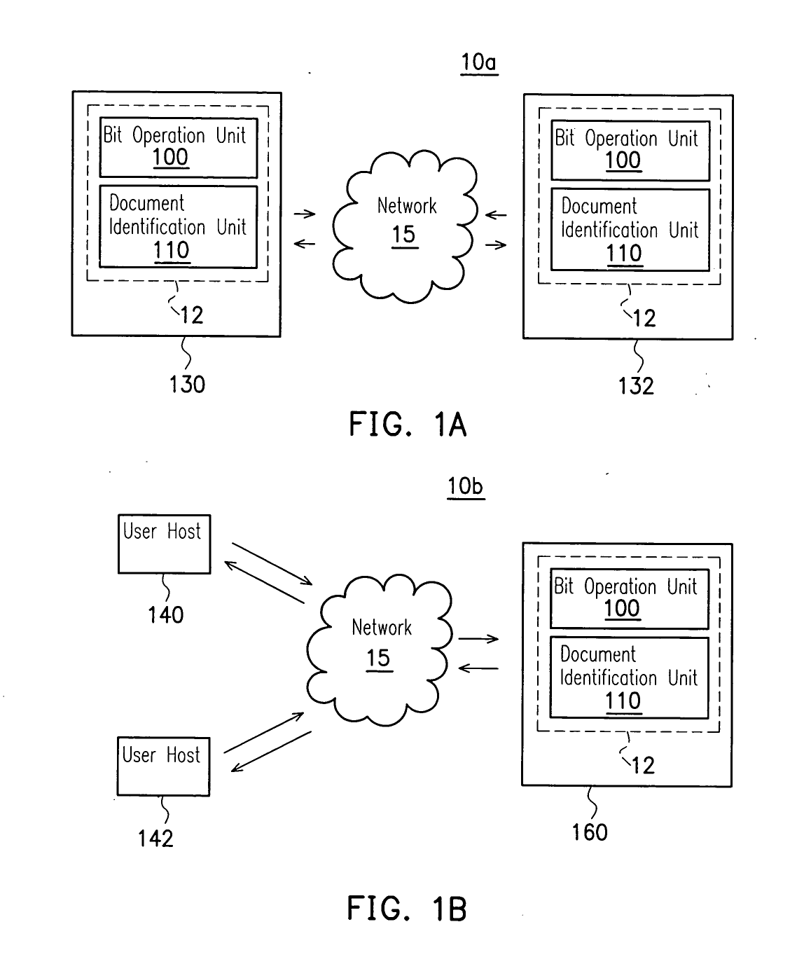

FIG. 1A is a schematic block diagram illustrating a system of a first preferred embodiment according to the present invention. In the first preferred embodiment, the network mailing system 10a, which is adapted to various present network protocols and configurations, comprises two user hosts 130 and 132, and a network 15 for delivering message between two user hosts 130 and 132. Moreover, both the user hosts 130 and 132 comprise a mail receiving/transmitting system 12 with document identification function according to the present invention.

Each mail receiving/transmitting system 12 comprises a bit operation unit 100 and a document identification unit 110. When a user host 130 sends an e-mail to another user host 132, the bit operation unit 100 therein exerts the operating method to obtain a corresponding padding value via calculating bit quantity of a specific text block in the e-mail based on a predetermined set of operating parameters. For convenience, in the embodiments of the present invention, the padding value before e-mail transmission is defined as the first padding value, and the padding value after e-mail receiving is defined as the second padding value. The foregoing predetermined operation parameters may include a character-block operation domain, such as the sender's name, subject, sending date, and/or body text. Moreover, the operation parameters further comprise a predetermined character-calculation direction, which may include four directions as characters arranged in the e-mail, such as top to bottom, bottom to top, left to right, or right to left. Notice that any combination of two or above directions that are selected from the four exerts sequential calculation of quantity of all characters so as to obtain required padding value.

Furthermore, the foregoing character-block operation domain may be a specific sector with predetermined bit-length in the bit operation unit 100, for example an operation domain of 10 bits or 20 bits, dividing the content of the e-mail.

In order to save the calculation time, all the embodiments of the present invention tend to exert a parity check method or an XOR operation method to calculate the foregoing padding value. In the present invention, however, operation method is not necessarily limited by these two examples. In addition, since the parity check method and the XOR operation method are known by one of the ordinary skill in the art, in order not to make the present invention trivial and confusing, remaining detail is omitted herein.

After the bit operation unit 100 of the user host 130 generates the required first padding value according to the method mentioned above, the fist padding value is further concatenated to the content of the e-mail, and the e-mail is then transmitted to the destination (e.g. the other user host 132) via the network 15.

It is to be noted that the first padding value mentioned above may be concatenated to any position in the e-mail based on a predetermined manner, for example, the padding value can be concatenated to the end of the predetermined text block following the selected text operation direction. As the full text content of an e-mail is selected as a character-block operation domain and a top to bottom (vertical) operation method is selected to calculate the bit-quantity of each column of the e-mail, a corresponding padding value is generated and concatenated to the tail of each column. Conversely, if the same character-block of the e-mail is selected and a left to right (horizontal) operation method is selected to calculate the bit-quantity of each line in the e-mail, a corresponding padding value is generated and concatenated to the rightmost of each line. It is understandable that assuming all four exemplary text operation directions are simultaneously exerted to the character block, each of the padding value obtained from respective direction method is distributed on the circumference of the e-mail content to form a frame. It will be apparent to one of the ordinary skilled in the art that all the operation directions for padding value calculation and the concatenation position are not the only implementations, however, one of the ordinary skilled in the art is free to determine an optimal method upon circumstances.

Furthermore, when the user host 132 has received an e-mail sent from the user host 130 via the network 15, the document identification unit 110 in the user host 132 obtains and compares the discrepancy between the padding values before the e-mail being sent and after the e-mail being received, so as to confirm correctness and completeness of the e-mail contents, that is to determine whether the e-mail content is tampered by third party during transmission. The operation method of the document identification unit 110 in the user host 132 is described as follows. A first padding value of the e-mail content is firstly obtained. A second padding value of the e-mail is thus re-calculated based on the same operation parameters and method. Lastly the discrepancy between the first padding value and the second padding value is determined so as to confirm the correctness of e-mail content that is transmitted. In other words, if the two padding values are identical, the transmitted e-mail is considered correct and complete, otherwise, the transmitted e-mail is considered disparate from the original that possibly suffers from tampering. Notice that protocols of operation parameters and method are unified in advance via a relay server (not shown) in order to serve the two user hosts 130 and 132.

In the foregoing first embodiment, however, if any one of the user hosts 130 or 132 is not configured the e-mail receiving/transmitting system 12, the mail identification function is then ineffective. Hence as FIG. 1B illustrates the second embodiment of this present invention, a foregoing mail transmitting/receiving system 12 configures a mail server 160 so that the user hosts 140 and 142 are not required to download or to be configured with the mail transmitting/receiving system yet perform equally to those in the first embodiment.

In FIG. 1B, when any one of the user hosts, for example, the user host 140 is to transmit an e-mail to the other user host 142, the e-mail is first sent via the network 15 in a network mailing system 10b so as to be sent to as well as processed by the mail server 160. The mail server 160 first calculates a first padding value for the received e-mail via bit operation unit 100 of the mail receiving/transmitting system 12 based on predetermined operating parameters and method. The server then concatenates the first padding value to the e-mail, and forwards the backup e-mail to destination address, which is user host 142 herein. Thereafter, if the user host 142 suspects the correctness of the received e-mail, a same operating parameters and method are exerted via the bit operating unit 100 of the mail server 160 on the e-mail to obtain a second padding value. Therefore comparison between the first padding value attaching to the received e-mail and the second padding value herein via document identification unit 110 of the mail server 160 manages to confirm whether the backup mail in mail server 160 is tampered during transmission to the host user 142. Similarly, if the other user host 140 suspects transmission security, a same operating parameters and method are exerted via the bit operating unit 100 of the mail server 160 on the sent e-mail stored in the user host 140 to obtain another second padding value. Thus comparison between the first padding value in the backup e-mail in the mail server 160 and another second padding value via document identification unit 110 of the mail server 160 manages to confirm whether the backup mail in mail server 160 is tampered during transmission to the host user 140.

Therefore, by implementing the second embodiment mentioned above, most users manage to transmit and receive e-mails via the mail server whereas concatenating or checking the padding values are automated therein. Accordingly, the opportunity of the mail receiving/transmitting system 12 being contacted by public is significantly reduced, and the security to the mail receiving/transmitting system is relatively raised as well.

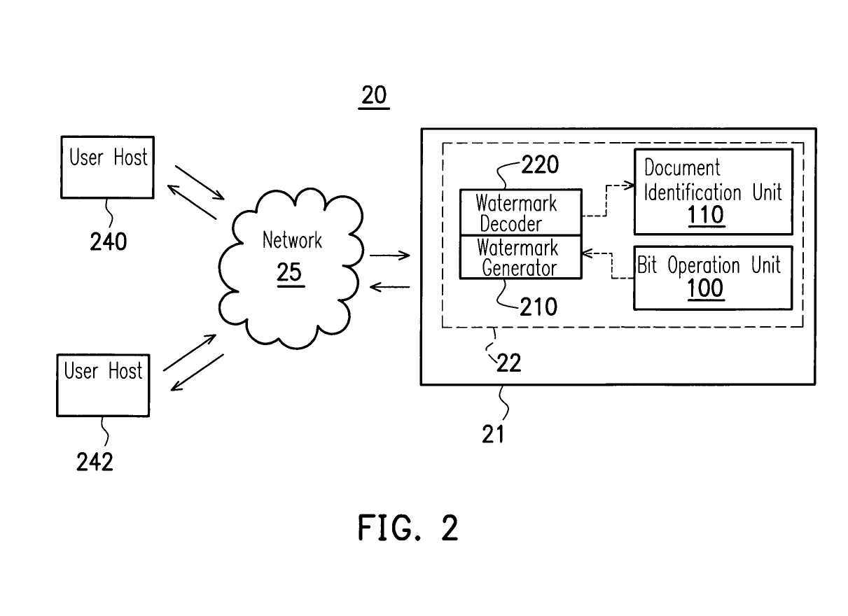

Furthermore, there is other preferred embodiment to implement the present invention. Referring to FIG. 2, it is a schematic structure block diagram illustrating a system of a third preferred embodiment according to the present invention. The mail receiving/transmitting system 22 with document identification function is disposed in a mail server 21 of a network mailing system 20, wherein the mail receiving/transmitting system 22 comprises a bit operation unit 100, a document identification unit 110, a watermark generator 210, and a watermark decoder 220.

In the third preferred embodiment of the present invention, the operations of the bit operation unit 100 and the document identification unit 110 are identical to those in the first and second embodiments, thus remaining detail is omitted herein. Yet the difference is that a first padding value of the received e-mail calculated via bit operating unit 100 based on predetermined operating parameters and method is further converted to a corresponding watermark via the watermark generator 210. The watermark is then concatenated to the e-mail and is represented as barcode or other images, the e-mail is backed up in mail server 2, as well as the watermarked e-mail is transmitted to destination via network 25, so as to increase correctness during transmission. Notice that the networks 15 and 25 mentioned in the second and third embodiments may be Intranet.

Moreover, when the correctness of the received e-mail needs to be verified on either of the user host 240 or 242, the watermark decoder 220 in the mail server 21 first converts the watermark of the received e-mail in the user host 240 or 242 back to the first padding value, and the bit operation unit 100 in the mail server 21 obtains a second padding value by operating on the received e-mail according to the same operation parameters and operation method. With the operation of the document identification unit 110 in the mail server 21 and comparison between the first padding value and the second padding value, it is determined that whether the e-mail is tampered by during e-mail receiving process. When arrival security of an e-mail sent by either user host 240 or 242 needs to be verified, the watermark in the back up mail fetched from mail server 21 is firstly converted back to the first padding value via the watermark decoder of mail server 21. A second padding value is then obtained via the same operating parameters and method in the mail server 21 exerted on the sent e-mails in either user host 240 or 242. Therefore, discrepancy between the first padding value and the second padding value is determined via the document identification unit 110 of the mail server 21 so as to confirm whether the e-mail being tampered during transmission as well as correctness and completeness of the e-mail content.

Since the watermark generator 210 and the watermark decoder 220 disclosed in the third embodiment concatenate the watermark rather than the simple padding value to the e-mail that is sent and received, other operation methods are all similar to that of the first embodiment in FIG. 1A, thus remaining detail is omitted herein.

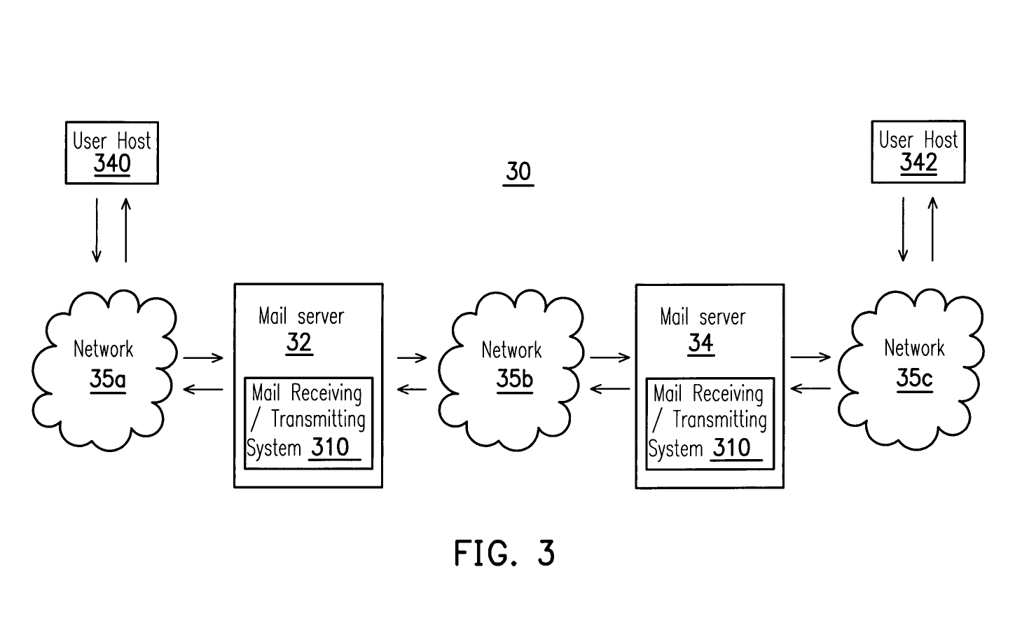

The present invention certainly applies to other various network mailing systems. Referring to FIG. 3, a schematic block diagram illustrates another network mailing system 30 of a fourth preferred embodiment according to the present invention. In the fourth embodiment, the network mailing system 30 comprises two user hosts 340 and 342 on two ends, and two mail servers 32 and 34 connected to the user hosts 340 and 342 respectively via networks 35a, 35b, and 35c. In this networking mailing system 30, the network 35b may be Internet and the networks 35a and 35c may be a LAN (Local Area Network) or a WAN (Wide Area Network). Both the two mail receiving/transmitting systems 310 comprised in the mail servers 32 and 34 may serve as the mail receiving/transmitting system 12 provided by the first or second preferred embodiment, or as the mail receiving/transmitting system 22 provided by the third preferred embodiment.

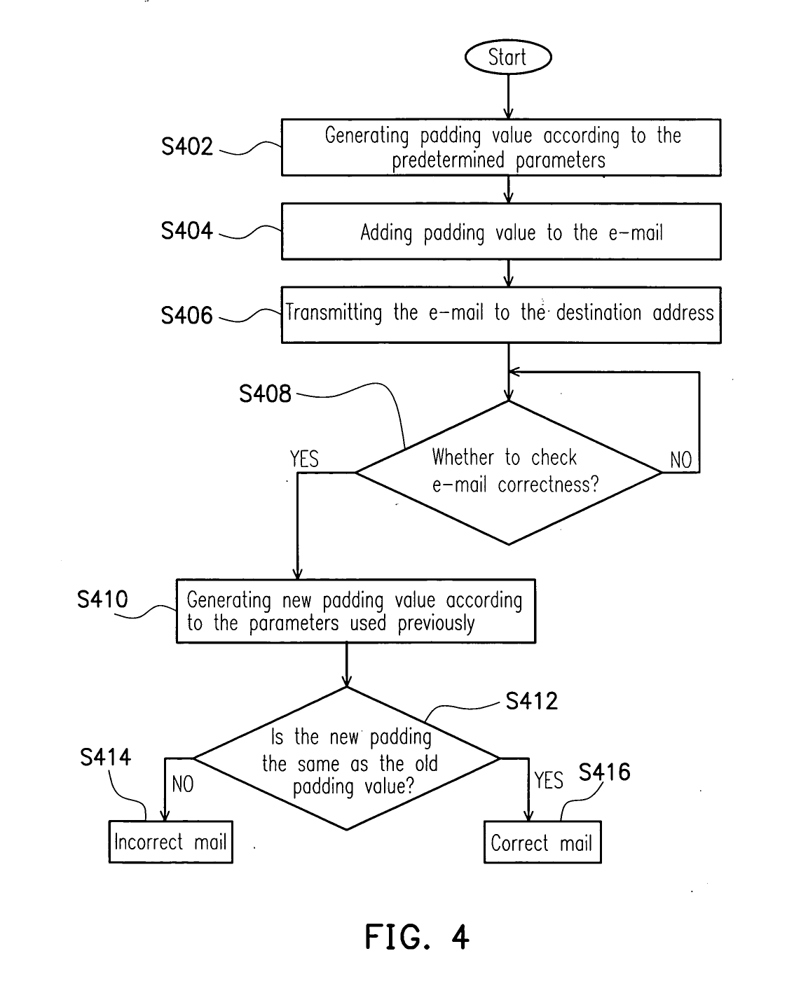

Finally, referring to FIG. 4, the process steps of the first and second preferred embodiments according to the present invention are illustrated therein. A corresponding padding value is firstly generated in step S402 based on predetermined operating parameters (including required operating direction, size of character blocks and operating method for generating padding value) and bit operating method as an e-mail being received by either the mail transmitting/receiving systems 12 or 22. These padding values are concatenated to the content of the received e-mails in step S404 and transmitted to predetermined destination address (e.g. any one of the user hosts) in the subsequent step S406.

Any of the user hosts at destination address manages to opt whether to check correctness of the received e-mail in step S408. If a user opts to check correctness of the e-mail, a new set of second padding values are generated corresponding to the received e-mail in step S410 according to the foregoing operating parameters and method. In step S412, the new second padding values are compared with the first padding values generated in step S402 in order to determine whether there is discrepancy between the two padding values. If these two values are identical, a mail-correct message is reported in step S416. Otherwise, an mail-incorrect message is reported in step S414 to indicate discrepancy. Similarly, step S404 is changed to “the padding value is converted into a watermark being concatenated to the e-mail therein” while all other steps in flowcharts for the third and the fourth embodiments (not shown) remain identical thus detail being omitted herein.

In summary, the present invention recognizes the correctness of e-mail by using a simple operation method, thus it greatly eliminates the security concerns for most mails.

Although the invention has been described with reference to a particular embodiment thereof, it will be apparent to one of the ordinary skill in the art that modifications to the described embodiment may be made without departing from the spirit of the invention. Accordingly, the scope of the invention will be defined by the attached claims not by the above detailed description.

1. A mail receiving/transmitting method with document identification function applying to a network mailing system, the mail receiving/transmitting method comprising:
calculating a quantity of bits of at least a specific text block in an e-mail during transmission so as to obtain a first padding value;
concatenating the first padding value to the e-mail;
transmitting the e-mail to a computer system via the network mailing system; and
obtaining the first padding value from the e-mail after receiving, such that the computer system verifies content correctness and completeness of the e-mail.

2. The mail receiving/transmitting method with document identification function as recited in claim 1, wherein a predetermined direction for calculating the quantity of bits in the specific text block in the e-mail comprises at least one out of the four directions including top to bottom, bottom to top, left to right, and right to left direction.

3. The mail receiving/transmitting method with document identification function as recited in claim 1, wherein the computer system is a mail receiving terminal.

4. The mail receiving/transmitting method with document identification function as recited in claim 1, wherein the computer system is a relay mail server.

5. The mail receiving/transmitting method with document identification function of claim 1, wherein the quantity of bits of the specific text block in the e-mail is calculated by an XOR operation method.

6. The mail receiving/transmitting method with document identification function of claim 1, wherein the quantity of bits of the specific text block in the e-mail is calculated by using a parity check method.

7. The mail receiving/transmitting method with document identification function as recited in claim 2, wherein the step of concatenating the first padding value to the e-mail is placing the first padding value at a predetermined position in the e-mail.

8. The mail receiving/transmitting method with document identification function of claim 1, wherein:
the step of concatenating the first padding value to the e-mail further comprises:
converting the first padding value into a watermark; and
concatenating the watermark to the e-mail; and
the step of obtaining the first padding value from the e-mail after receiving further comprises:
converting the watermark in the e-mail into the first padding value.

9. The mail receiving/transmitting method with document identification function of claim 8, wherein the step of concatenating the watermark to the e-mail comprises placing the watermark at a predetermined position in the e-mail.

10. The mail receiving/transmitting method with document identification function of claim 1, wherein the step verifying e-mail correctness and completeness comprises:
obtaining a second padding value by calculating the quantity of bits of the text block in the received e-mail; and
comparing the second padding value with the first padding value so as to determine whether the e-mail is tampered.

11. A mail receiving/transmitting method with document identification function applying to a network mailing system, comprising:
calculating bits of a specific text block in the e-mail during transmission so as to obtain a watermark;
concatenating the watermark to the e-mail;
transmitting the e-mail to a computer system via the network mailing system; and
obtaining the watermark from the e-mail after receiving, such that the computer system verifies content correctness and completeness of the e-mail.

12. The mail receiving/transmitting method with document identification function as recited in claim 11, wherein the step of generating the watermark further comprises:
obtaining a first padding value by calculating a quantity of bits of the specific text block in the e-mail; and
converting the first padding value into the watermark.

13. The mail receiving/transmitting method with document identification function of claim 11, wherein the step of concatenating the watermark to the e-mail comprises placing the watermark at a predetermined position in the e-mail.

14. The mail receiving/transmitting method with document identification function as recited in claim 12, wherein the step that computer system verifies content correctness and completeness further comprises:
converting the watermark into the first padding value;
obtaining a second padding value by calculating a quantity of bits of the text block in the e-mail after receiving; and
comparing the second padding value with the first padding value, so as to determine whether the e-mail is tampered.

15. A mail receiving/transmitting method with document identification function applying to a network mailing system, comprising:
calculating a quantity of bits of a specific text block in the e-mail during preparation of e-mail transmission so as to generate a watermark which appears in the e-mail based on a calculation result;
transmitting the e-mail to a computer system via the network mailing system;
the computer system reading the calculation result recorded by the watermark in the e-mail; and
comparing discrepancy between a quantity of bits of the specific text block in the e-mail after receiving and the calculation result recorded by the watermark so as to determine whether the e-mail is tampered during transmission.

16. The mail receiving/transmitting method with document identification function as recited in claim 15, wherein the calculation result of the quantity of bits of the specific text block in the e-mail is a padding value.

17. A mail receiving/transmitting system with document identification function applying to a network mailing system having a transmitting terminal and a receiving terminal, the mail receiving/transmitting system comprising:
a bit operation unit for calculating a quantity of bits of a specific text block in the e-mail so as to obtain a first padding value during e-mail transmission/receiving of the network mailing system; and
a document identification unit for obtaining and comparing the padding value discrepancy between before the e-mail being sent and after the e-mail being received via the network mailing system so as to confirm correctness and completeness of content of the e-mail.

18. The mail receiving/transmitting system with document identification function as recited in claim 17, wherein the bit operation unit obtains the specific text block according to a predetermined direction in the e-mail.

19. The mail receiving/transmitting system with document identification function as recited in claim 17, wherein the mail receiving/transmitting system is installed in each the receiving terminal and the transmitting terminal of the network mailing system.

20. The mail receiving/transmitting system with document identification function as recited in claim 17, wherein the network mailing system further comprises a mail server, and the mail receiving/transmitting system is installed therein.

21. The mail receiving/transmitting system with document identification function as recited in claim 17, wherein the operation method used by the bit operation unit comprises at least one of an XOR operation method and a parity check method.

22. The mail receiving/transmitting system with document identification function as recited in claim 17, wherein the bit operation unit stores the padding value at a specific position in the e-mail during transmission of the e-mail via the network mailing system.

23. The mail receiving/transmitting system with document identification function as recited in claim 17, further comprising:
a watermark generator for converting the padding value into a watermark and storing the watermark at a specific position in the e-mail during preparation of transmitting the e-mail via the network mailing system; and
a watermark decoder for converting the watermark in the e-mail into the padding value for the document identification unit for comparison after receiving the e-mail via the network mailing system.
